(19) United States
(12) Patent Application Publication
(10) Pub. No.: US 2006/0141844 A1
(43) Pub. Date: Jun. 29, 2006

(54) Cam connector with set screw

(76) Inventor: Anthony Tufano JR., Seaford, NY (US)

Correspondence Address: PAUL J. SUTTON, ESQ., BARRY G. MAGIDOFF, ESQ.;GREENBERG TRAURIG, LLP, 200 PARK AVENUE, NEW YORK, NY, 10166, US

(21) Appl. No.: 11/023,322

(22) Filed: Dec. 27, 2004

(51) Int. Cl. H01R 13/627

(52) U.S. Cl. 439/350

(57) ABSTRACT

A cam connector includes a contact pin and an intermatable pin receptacle. The cam connector can be mated by inserting the pin in the receptacle and rotating the elements with respect to one another. A latch enables rotation of the contact pin and pin receptacle in a first direction to intermate and inhibits the rotation of the contact pin and pin receptacle in a second direction to disengage the pin from the receptacle. The contact pin and the pin receptacle may be secured within respective housings by a set screw.

### 1. FIELD

The present disclosure relates to electrical connectors.

### 2. BACKGROUND OF RELATED ART

Electrical connectors may be used to connect a first electrical wire to a second electrical wire. The connector can include a contact pin coupled to the first wire and an intermatable pin receptacle coupled to the second wire. The first and second wires are electrically connected when the contact pin is mated with the pin receptacle.

A cam connector is a type of connector that may include cam locking device. A cam connector contact pin may have a protrusion (i.e., cam follower). The pin receptacle may have a channel to receive the cam follower. The channel can be a spiral path into the pin receptacle. When the contact pin is intermated with the pin receptacle, the cam follower fits into the channel. Rotation of the contact pin in the pin receptacle can cause the cam follower to be drawn along the spiral channel causing the pin contact and pin receptacle to mate. Reversal of rotation of the contact pin disassembles the connector pin from the pin receptacle.

Electrical cables can be coupled to the connector elements. Each element may be electrically insulated by an insulating housing. The housing can have an opening to fit over electrical cables that enter the housing. The housing may be secured to the entering cable by, for example, bonding or vulcanizing the housing to the insulation on the cable.

Cam connectors and receptacles may be used in supplying relatively high voltage (e.g., 480 volts) alternating current (AC) 3-phase power to relatively large electrical loads. A ship at dockside is one example of a large electrical load because of the power levels required by the ship's lighting, heating, etc., for example. When the ship is at dockside (i.e., not providing its own power), electrical power can be supplied from dockside cables having power from a land-based source. A cable from the ship may be coupled to the pin receptacle of the cam connector and the mating dockside cable coupled to the contact pin. Disassembly of the connector while current is flowing through the connector can create a hazardous shock condition for personnel. The disassembly also may occur unintentionally, for example by vibrations or by turning and twisting movements of the cables in use, which, again could result in a dangerous and even life threatening situation.

### SUMMARY OF THE INVENTION

Apparatus and methods are disclosed to reduce the likelihood of disengagement of a cam connector by including a latch. The cam connector includes a contact pin and an intermatable pin receptacle. The cam connector can be mated by inserting the pin in the receptacle and rotating the elements with respect to one another. The latch enables rotation of the elements in a first direction to intermate, and inhibits the rotation of the pin and receptacle in a second direction to disengage the pin from the receptacle.

A latch release enables the elements to rotate with respect to one another in a direction to disengage the contact pin from the pin receptacle.

In another aspect, the contact pin is mounted in a contact pin housing. A set screw in the housing inhibits movement of the contact pin.

In another aspect, The pin receptacle is mounted in a pin receptacle housing. A set screw in the housing inhibits movement of the pin receptacle in the pin receptacle housing.

In another aspect, the pin receptacle housing and the contact pin housing have a tapered end including removable portions which, when each is removed, enable the receptacle housing to receive a larger wire gauge.

Some of the implementations of the disclosed techniques may include one or more of the following advantages. The connector of the present disclosure can provide insulated connections that positively lock into place and thus are resistant to accidental or unintended disassembly due to vibration. The connector elements can be retrofitted to existing locations and power distribution systems. A latch release on one of the connector elements can release the cam latch mechanism for quick connect/disconnect of the connector elements by a twist and pull motion.

### BRIEF DESCRIPTION OF THE DRAWINGS

Additional objects, features and advantages of the present disclosure will become apparent from the following detailed description taken in conjunction with the accompanying drawings, in which:

FIG. 1A is an illustration of a contact pin and a pin receptacle including a latch.

FIG. 1B is a detailed view illustrating latching teeth of the pin receptacle of FIG. 1A.

FIG. 2 is partial view illustrating an implementation of a latch.

FIGS. 3A-3B are a cross-sectional views of the contact pin of FIG. 1A illustrating an implementation of a latching protrusion in a locked and a released position, respectively;

FIGS. 4A-B are views of a contact pin housing illustrating a set screw and latch release, respectively.

FIG. 5 is an illustration of a pin receptacle housing.

For purposes of brevity and clarity, like elements will have the same numerical designation throughout the figures.

### DETAILED DESCRIPTION

In a cam connector, a cam may be mounted on a first element of a connector such as a contact pin, for example. A camming channel may spiral around the periphery of a second element of the connector such as a pin receptacle, for example. When the connectors elements are intermated, the cam can engage the camming channel. Rotation of the elements in a first direction with respect to one another can cause the cam to ride along the camming channel. Because the camming channel spirals along the pin receptacle, the contact pin can be drawn into closer engagement with the receptacle. In a similar manner, the elements may be disengaged by rotating the elements in a direction opposite to the first direction. A latch may be included to allow only rotation in one direction to engage the elements. Rotation in a second direction to disengage the elements can be accomplished only when the latch is released.

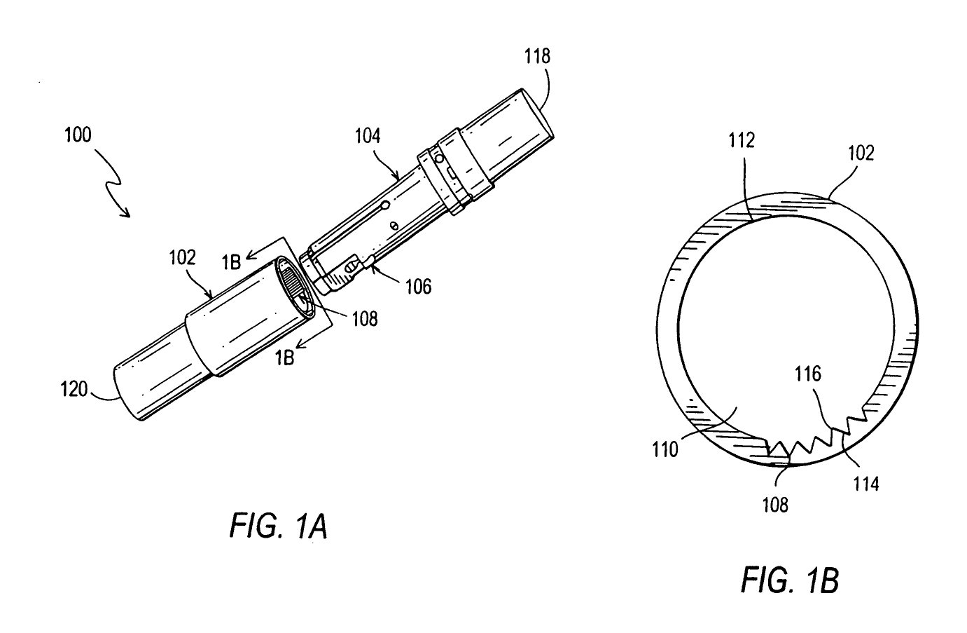

FIGS. 1A-1B illustrate a connector assembly 100 having a contact pin 104 and an intermatable pin receptacle 102. In an implementation, a latching mechanism may include a latching protrusion 106 rotatably attached to the contact pin 104 and biased to protrude therefrom. The latching protrusion 106 can rotate into the contact pin 104 so as not to protrude therefrom. A latch release (not shown) described below, may be actuated to overcome the bias and cause the latching protrusion 106 to rotate into the contact pin 104. The pin receptacle 102 can include latching teeth 108. The latching teeth 108 can be arranged around an inside periphery 112 of a bore 110, which can be sized to receive the contact pin 104. The latching protrusion 106 is sized to fit into the latching teeth 108. The latching teeth 108 may have a sawtooth shape so that a leading edge 114 has a slope different from a trailing edge 116 with respect to periphery 112. When the latching protrusion 106 is engaged with the latching teeth, the latching teeth enable the latching protrusion to ratchet along the latching teeth in only one direction as described in greater detail below. In an implementation, the latching protrusion may have a triangular cross-sectional shape. Both the contact pin 104 and the pin receptacle 102 can have a recess 120, 118, respectively, to receive an electrical wire.

The contact pin 104 can be intermated with the pin receptacle 102 by moving the contact pin into the receptacle bore 110. Because the latching protrusion 106 is rotatably attached to the contact pin 104, the latching protrusion 106 is urged into the contact pin 110 by the pin receptacle inside periphery 112 as the pin is engaged into the receptacle. As the pin and receptacle are rotated with respect to one another, the latching protrusion 106 will engage the latching teeth 108. The bias on the latching protrusion 106 will rotate latching protrusion to protrude from the contact pin and engage the latching teeth 108.

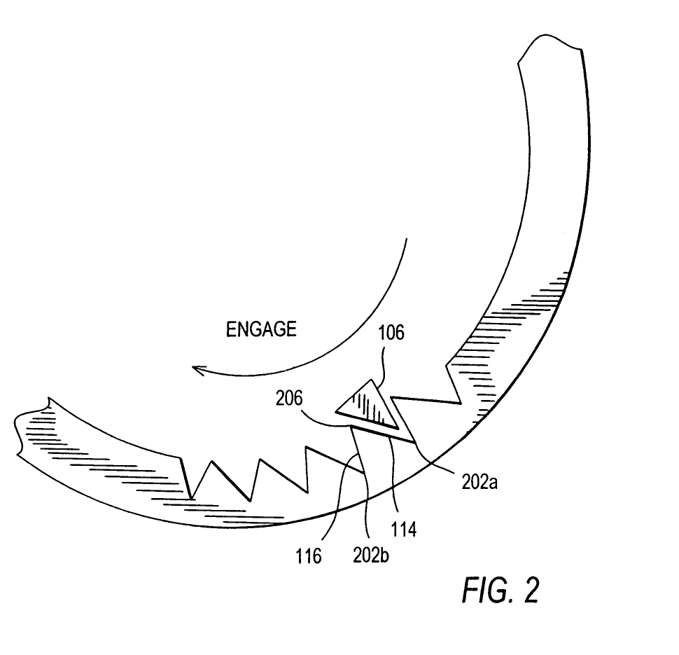

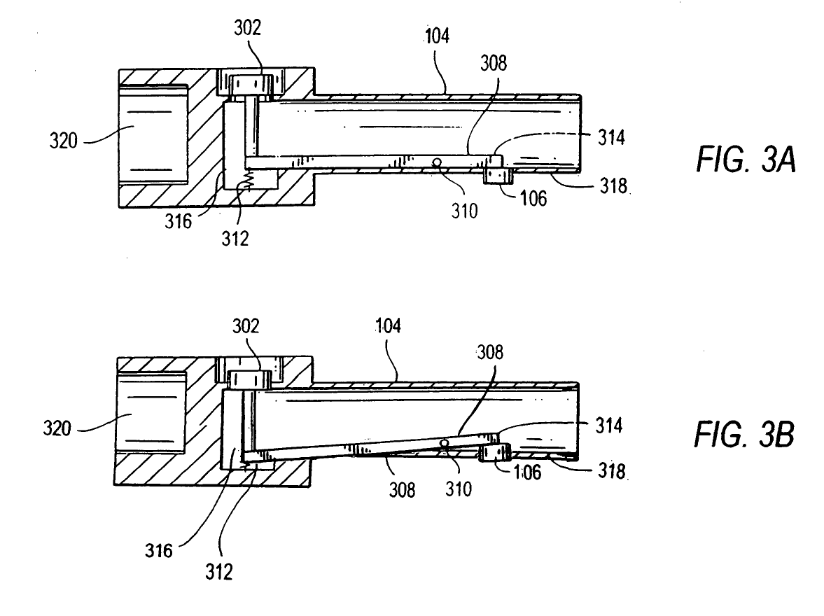

FIG. 2 illustrates a cross-sectional view of an implementation of the latching protrusion 106 engaged with the latching teeth 108. In the example shown, the latching protrusion has a triangular cross-sectional shape. When the pin is rotated to engage the receptacle, the latching protrusion 106 rotates to engage the latching teeth 108 and slides into the recess 202a of the teeth. Because of the triangular cross-sectional shape of the latching protrusion 106 and a first slope of the leading edge 114 of the latching teeth, the latching protrusion can ride up along the leading edge 114 of the latching teeth as the contact pin is rotated to engage the pin receptacle. The latching protrusion then can ratchet into the next latching tooth recess 202b. The trailing edge 116 of the latching teeth has a second slope different from the leading edge 114 with respect to the periphery at point 206. The second slope is chosen to inhibit the latching protrusion 106 from riding up the trailing edge 116 and, thus, inhibits rotation of the contact pin in a direction to disengage from the pin receptacle. When a latch release (not shown) is actuated, the latching protrusion 106 can rotate out of the latching teeth 108 recess and into the contact pin as shown in FIG. 3B. With the latching protrusion 106 disengaged from the latching teeth 108, the contact pin can be freely rotated in a direction to disengage the pin from the receptacle.

FIGS. 3A-3B illustrate an implementation of a contact pin 304 having a latch release actuator 302. A latching protrusion 306 may be coupled to a first end 314 of a latch arm 308. The latch arm 308 can be pivotally attached to the contact pin 304 and rotate about a pivot 310. A release actuator 302 can be coupled to a second end 316 of the latch arm 308. A bias means 312, such as a spring, also can act on the second end 316 of the latch arm 308 to bias the latch arm 308 in an orientation such that the latching protrusion 306 protrudes from a contact pin outer surface 318. FIG. 3A illustrates the contact pin 304 having the latching protrusion 306 protruding from the contact pin 304. The contact pin 304 also may have a bore 320 to receive an electrical wire.

FIG. 3B illustrates the contact pin 304 with the latch release 302 actuated. A force applied to the latch release actuator 302 can overcome the force of the biasing means 312 to pivot the latch arm 308 about pivot 310. Pivoting of the latch arm 308 in turn retracts the latching protrusion 306 into the contact pin 304. Thus, the latching protrusion 306 may not protrude from the contact pin outer surface 318. When the latching protrusion 306 does not protrude from the contact pin outer surface 318 the contact pin and pin receptacle may be rotated with respect to one another in a direction to disengage the contact pin from the pin receptacle. When the latching protrusion 306 protrudes from the contact pin outer surface 318 the contact pin and pin receptacle may only be rotated with respect to one another in a direction to engage the contact pin with the pin receptacle.

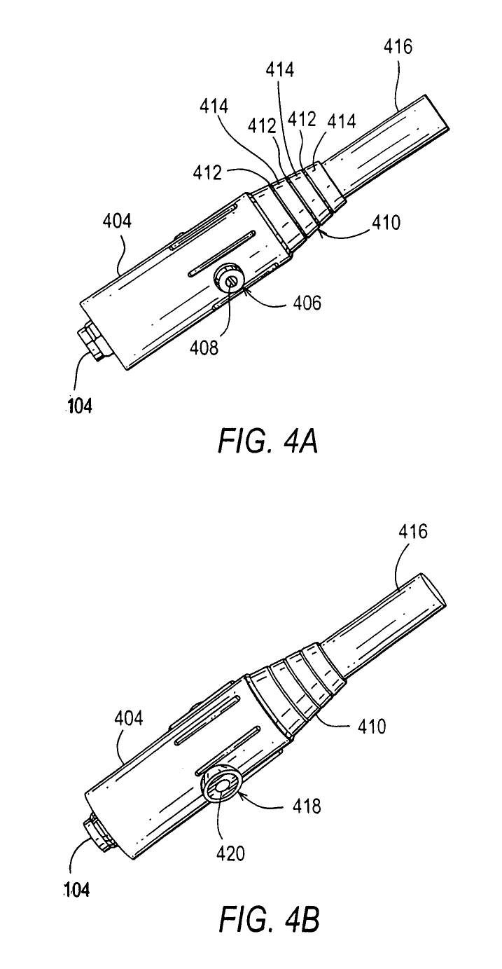

FIGS. 4A-4B are views of a contact pin housing 404 surrounding a contact pin 402 illustrating a first set screw 408 and latch release 420, respectively. The contact pin housing 404 may be fabricated from any suitable insulation material. In an implementation, the contact pin housing may be made of a material which can be injection molded and can include ultraviolet (UV) stability. The contact pin housing 404 includes a first set screw hole 406, which may be threaded to receive a first set screw 408. The first set screw 408 may be screwed into the contact pin housing 404 to make contact with the contact pin 402 inside the contact pin housing. Sufficient rotation of the first set screw can secure the contact pin housing 404 to the contact pin 402 and inhibit movement of the contact pin 402 within the contact pin housing 404. The contact pin housing 404 also may have a tapered end 410. The tapered end 410 can have an opening to fit over an insulation of an electrical wire (not part of the disclosure). The electrical wire may be coupled to the contact pin. In an implementation, the tapered end 410 can have notched rings 412 defining removable portions 414 of the tapered end. The contact pin housing 404 also may include an opening 418 to provide access to a latch release 420 of the contact pin 402. In an alternative implementation, the contact pin housing 404 may have a latch release extension (not shown) that can be coupled to the latch release.

The tapered end 410 can fit around the insulation of the electrical wire 416. The notched rings 412 can be positioned to mark locations where the tapered end 410 may be cut to remove one or more removable portions 414. In this manner, the opening in the tapered end may be widened to accept larger gauges of electrical wire. The contact pin 402 may be secured within the contact pin housing 404 by appropriate removal of the removable portions 414 and use of the first set screw 408. The disclosed assembly can provide for reusable contact pin housings and contact pins because the electrical wire insulation is not attached, for example by bonding, heating or vulcanization, to the contact pin housing.

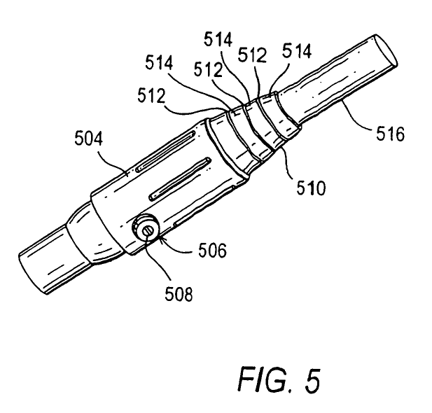

FIG. 5 illustrates a pin receptacle housing 504. The pin receptacle housing 504 may be fabricated from any suitable insulation material. In an implementation, the pin receptacle housing may be made of may be made of a material which can be injection molded and can include ultraviolet (UV) stability. The pin receptacle housing 504 includes a second set screw hole 506, which may be threaded to receive a second set screw 508. The second set screw 508 may be screwed into the pin receptacle housing 504 to impinge on the pin receptacle (not shown) inside the pin receptacle housing. Action of the second set screw 508 can secure the pin receptacle housing 504 to the pin receptacle and inhibit movement of the pin receptacle within the pin receptacle housing 504. The pin receptacle housing 504 also may have a tapered end 510. The tapered end can have an opening to fit over an insulation of an electrical wire 516 (not part of the disclosure). The electrical wire 516 may be coupled to the pin receptacle. In an implementation, the tapered end 510 can have notched rings 512 defining removable portions 514 of the tapered end.

The tapered end 510 can fit around the insulation of the electrical wire 516. The notched rings 512 can be positioned to mark locations where the tapered end 510 may be cut to remove one or more removable portions 514. In this manner, the opening in the tapered end may be widened to accept larger gauges of electrical wire. The pin receptacle may be secured within the pin receptacle housing 504 by appropriate removal of the removable portions 514 and use of the second set screw 508. The disclosed assembly can provide for reusable pin receptacle housings and pin receptacles because the electrical wire insulation is not attached, for example by vulcanization, to the pin receptacle housing.

While there have been shown and described and pointed out the fundamental features of the disclosure, as is presently contemplated for carrying them out, it will be understood that various omissions and substitutions and changes of the form and details of the device described and illustrated and in its operation may be made by those skilled in the art, without departing from the spirit of the invention. As such, other embodiments are within the scope of the following claims.

1-5. (canceled)

6. A connector assembly, comprising:
a contact pin;
a contact pin housing surrounding the contact pin and having a first set screw hole and a tapered end, wherein the tapered end has spaced apart notched rings wherein the notches are indentations which define removable portions therebetween, when removed, enable the contact pin housing to receive wires of different size gauges; and
a set screw threaded into the first set screw hole to engage and lock said housing to the contact pin.

7. (canceled)

8. The connector assembly of claim 6, comprising:
a latch arm pivotally attached to the contact pin;
a latch actuator coupled to a first end of the latch arm; and
biasing means to bias the latch actuator to a first position,
wherein when the latch actuator is in the first position a second end of the latch protrudes from the contact pin and when the latch actuator is urged to a second position the second end of the latch arm does not protrude from the contact pin.

9. The connector assembly of claim 8, wherein the second end of the latch has a

10. The connector assembly of claim 8, wherein the biasing means comprises a spring.

11. The connector assembly of claim 8, comprising:
a pin receptacle having a bore to mate with the contact pin, the bore having latching teeth on an inside periphery to receive the second end of the latch protruding from the contact pin;
a pin receptacle housing surrounding the pin receptacle and having a tapered and a second set screw hole; and
a set screw threaded into the second set screw hole and in contact with the pin receptacle to inhibit movement of the pin receptacle within the pin receptacle housing.

12. The connector assembly of claim 11, wherein the tapered end comprises removable portions which, when each is removed, enable the receptacle housing to receive a larger wire gauge.

13-16. (canceled)
